(19) United States
(12) Patent Application Publication
(10) Pub. No.: US 2025/0276635 A1
(43) Pub. Date: Sep. 4, 2025

(54) Retractable Vehicle Safety Sign Device

(71) Applicant: Tommy Burns, Palm Coast, FL (US)

(72) Inventor: Tommy Burns, Palm Coast, FL (US)

(21) Appl. No.: 19/070,257

(22) Filed: Mar. 4, 2025

Related U.S. Application Data
(60) Provisional application No. 63/560,847, filed on Mar. 4, 2024.

(51) Int. Cl. B60Q 1/50; B60Q 1/26

(52) U.S. Cl. CPC B60Q 1/547; B60Q 1/2692

(57) ABSTRACT

A retractable vehicular safety sign device is disclosed for providing enhanced safety for school age children and individuals using public transportation, such as but not limited to a school bus crossing a roadway. The retractable safety sign device comprises a mounting bracket with a hinge component for extending and retracting the safety sign. The device has a reflective element, an audio element, and a camera, located on the sign for increased safety. Further, the retractable safety device extends and retracts from a control that is comprised of a button and a battery which is rechargeable. Finally, the control for the device has an adhesive element that can be secured to the dashboard of a vehicle for ease and convenience.

### CROSS-REFERENCE TO RELATED APPLICATION

The present application claims priority to, and the benefit of, U.S. Provisional Application No. 63/560,847, which was filed on Mar. 4, 2024, and is incorporated herein by reference in its entirety.

### FIELD OF THE INVENTION

The present invention relates generally to the field of vehicle safety sign devices. More specifically, the present invention relates to an improved vehicle safety sign device. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in vehicle safety sign devices. Generally, many vehicles do not stop as required by the law when school buses extend the attached stop sign. Further, other public transportation vehicles face similar problems involving the safety of their passengers. Drivers of school children or public transportation vehicles need a device to improve the safety of their passengers.

Further, with the added problem of distracted drivers due to talking or texting on their mobile device, drivers lose focus and may not stop when school buses extend a stop sign, causing potential injury to children as they cross the street. Moreover, children may incur a more serious injury or even fatality. Further, many cities have public transportation available for community members that are disabled, elderly, or do not drive, therefore, the device is not limited to the enhanced safety of school age children. Without a retractable safety sign or similar device, the school age children, users of public transportation, and pedestrians may be at risk for potential injury from vehicles when crossing the street. However, most vehicle safety signs are not retractable and can be difficult to see or are not easily visible by drivers.

Accordingly, there is a demand for an improved retractable vehicle safety sign device that provides enhanced safety for school age children when they are crossing the street. More particularly, there is a demand for a retractable vehicle safety sign device that is activated wirelessly for ease and convenience.

Therefore, there exists a long felt need in the art for an improved safety sign device for school buses or school transportation vehicles. There also exists a long felt need in the art for a retractable vehicle safety sign device that can be used on a school bus or other means of transportation to prevent automobiles from passing while children are crossing the street in front of the vehicle. Further, there is a long felt need in the art for a retractable vehicle safety sign device that has a wireless activation remote or button on the dashboard of the vehicle. Moreover, there is a long felt need in the art for a safety sign device with a retractable bar with an extension long enough to reach across the street or road to prevent vehicles from passing the bus or other public transportation vehicle. Further, there is a long felt need in the art for a retractable vehicle safety sign with video or audio components for added safety. Finally, there is a long felt need in the art for a vehicle safety sign with LED illumination for high visibility.

The subject matter disclosed and claimed herein, in one embodiment thereof, comprises a retractable vehicle safety device. The device is a vehicle safety sign to prevent automobiles from encroaching on buses or other forms of public transportation pedestrian zones, thereby enhancing the safety of children or passengers when boarding or alighting. The retractable vehicle safety sign device is comprised of a sign and a traffic-lane-blocking arm that is manufactured to extend across the street. The device is comprised of at least one mounting bracket and may be manufactured in a variety of sizes, shapes, and configurations. The device is comprised of at least one arm that connects to the mounting bracket via at least one hinge. More specifically, the device preferably manufactured from aluminum or other weather resistant material known in the art. Further, the device is comprised of an LED border and uses wireless activation for high visibility and ease of use. Finally, the device is comprised of an audio and video feature to provide enhanced safety and security.

In this manner, the retractable vehicle safety device of the present invention accomplishes all of the forgoing objectives and provides users with a device that provides increased safety and security transporting school age children or pedestrians. The device has wireless activation for convenience and ease of use. More specifically, the device has an LED border for high visibility and increased safety. Finally, the device is designed with an audio and video component to prevent potential injury to children going to and from school, the device is not limited to school buses and may be secured to a variety of vehicles for enhanced safety.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a retractable vehicle safety sign device. The device is comprised of a sign and traffic-lane-blocking arm that can be extended from the side surface of a vehicle such as but not limited to a school bus. As a result, the sign warns drivers in a lane next to the vehicle to stop, and the arm prohibits the drivers from driving past the vehicle. This increases the odds that children crossing the roadway cannot be hit by drivers in other lanes.

In one embodiment, the retractable safety sign device has particular utility in safely transporting school children or passengers to and from their desired destination. In the present invention, the retractable vehicle safety sign device can be attached to a side surface of a vehicle via the mounting bracket via at least one fastener such as but not limited to a screw, bold, etc. Although the device is designed to attach to a side surface, such as but not limited to a bus, the device adapts to various vehicles for added safety and security.

In one embodiment, the device is comprised of at least one mounting bracket and at least one through opening for secure installation. The bracket may be manufactured in any shape, size or configuration suitable as is known in the art. The mounting bracket is typically metal, such as aluminum or steel, but could also be manufactured of any durable weather and rust resistant material known in the art, as well.

In one embodiment, the bracket can be attached to a side surface of a vehicle, such as but not limited to a bus via at least one fastener. The fastener may include but not limited to a screw, a bolt, or other fastener know in the art.

In one embodiment, at least one arm is connected to the mounting bracket via at least one hinge of any type. Furthermore, at least one powered arm connects the arm to the bracket. In one embodiment, the arm may attach to the bracket via at least one hinge. Further, the arm is preferably a hydraulic or electric powered arm. Moreover, the hydraulic or electric powered the extended arm to reach 90-degrees relative to the horizontal axis of the bracket. In this manner, the extended arm can be positioned generally parallel with the side surface of a vehicle when not stored and not in use. When deployed, the arm extends from the bracket to a perpendicular position in order to block a lane of traffic as well as position one sign in the lane for safety.

In one embodiment, the arm is comprised of at least one channel, wherein the hydraulic or powered arm can move laterally within the channel. Specifically, when the arm is extended or retracted.

In one embodiment, the device is comprised of at least one sign attached to the extended arm. The sign is preferably red and octagonal in shape, but may be any shape and any color. The front surface and/or the rear surface of the sign may also be comprised of at least one indicia. Further, the front surface and/or the rear surface of the arm may also be comprised of at least one indicia. The indicia is preferably “stop” but may be any word, phrase, symbol, etc. that may relate to stopping traffic and indicating passengers or occupants of the vehicle are crossing the roadway. Further, the arm and sign, the front surfaces and/or rear surfaces may be comprised of a least one reflective element of any color and at least one light to ensure visibility. In one embodiment, the device is comprised of at least one light that may illuminate in any pattern such as but not limited to continuous illuminate, flashing illumination, etc.

In one embodiment, the device is comprised of at least one camera attached to the sign. The camera is preferably wireless and automatically activated when the device is extended to capture images and sounds of vehicles not in compliance with traffic safety laws. In yet another embodiment, the device is comprised of a least one sound alert that may ring in any pattern such as but not limited to continuous, intermittently, etc. The sound alert is preferably wireless and automatically activated when the device is extended as a warning to drivers. Typically, the camera and sound alert act as enhanced safety features for children and pedestrians.

In one embodiment, the device is comprised of an arm preferably in wired or wireless communication with at least one control. Further, the control may be positioned within the vehicle such as but not limited to the dashboard. In one embodiment, the control button mounts to the dashboard of a vehicle with an adhesive such as but not limited to latch, hook and loop, or other known in the art. Further, positioning the control button on the dashboard provides easy access to engage the device when passengers are exiting the bus or other vehicle. Moreover, when at least one button of the control is pressed, the arm extends and/or the arm retracts for convenience and enhanced safety.

In yet another embodiment, a method of using the retractable safety sign device is disclosed. The method includes the steps of providing a retractable vehicle safety sign device comprising at least one sign, at least one control, at least one mounting bracket, and at least one arm attached to the mounting bracket via at least one hinge and at least one arm. Then, the method comprises securing the mounting bracket to a side surface of a vehicle. Next, the method comprises depressing a button to deploy the arm from the bracket such that the arm is deployed generally 90-degrees (i.e., orthogonally) from the horizontal axis when the vehicle stops and riders of the vehicle may be crossing the roadway. Finally, the method comprises retracting the arm once the riders have crossed the street by pressing the button to store the device securely.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the retractable safety sign device of the present invention displaying the front surface of the sign in accordance with the disclosed architecture;

FIG. 2 illustrates a perspective view of one embodiment of the retractable safety sign device of the present invention showing the rear surface of the sign in accordance with the disclosed architecture;

FIG. 3 illustrates a perspective view of one embodiment of retractable safety sign device of the present invention showing the device retracted in accordance with the disclosed architecture;

FIG. 4 illustrates a perspective view of one embodiment of the retractable safety sign device of the present invention showing the control component in accordance with the disclosed architecture;

FIGS. 5A, 5B, 5C, and 5D illustrate perspective views of one embodiment of the retractable safety sign device of the present invention showing the device installed including specifics in accordance with the disclosed architecture; and

FIG. 6 illustrates a flowchart showing the method of easily utilizing the retractable safety sign device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a retractable safety sign device that provides that can be used on school buses or other vehicles. There is also a long felt need in the art for a retractable safety sign device that utilizes wireless activation. Further, there is a long felt need in the art for a retractable safety sign device that extends the length of the road for increased safety. Moreover, there is a long felt need in the art for a device that has a metal frame and bracket that can be attached to the side surface of any vehicle. Further, there is a long felt need in the art for a retractable safety sign device that uses colors, words, phrases, symbols, and a reflective or illuminating component for high visibility. Moreover, there is a long felt need in the art for a retractable safety sign device that uses video and sound features for added safety. Finally, there is a long felt need in the art for a retractable safety sign device that is easily deployed for enhanced safety.

The present invention, in one exemplary embodiment, is a novel retractable safety sign device. The retractable safety sign device comprises a mounting bracket component with at least one through opening to secure the device to the side surface of a vehicle. Further, the device comprises at least one hinge and at least one arm to extend. Further, the mounting bracket, hinge, and arm are preferably manufactured with an aluminum or other durable weather resistant metal material known in the art. Further, the arm and channel preferably comprise a hydraulic or electric powered system to enable ease of use. Moreover, the control component comprises a battery-operated button which is rechargeable to activate the device with ease. The present invention also includes a novel method of easily engaging the device. The present invention is also comprised of a method of using the device. First, a device is provided comprised of at least one sign, at least one control, at least one mounting bracket, and at least one arm attached to the mounting bracket via at least one hinge and at least one arm. Then, the mounting bracket can be secured to a side surface of a vehicle. Next, a button of the control can be depressed to deploy the arm from the bracket such that the arm is deployed generally 90-degrees (i.e., orthogonally) from the horizontal axis of the bracket when the vehicle stops and riders of the vehicle may be crossing a roadway. Finally, once the riders have crossed, the button can be pressed to retract the arm such that it is generally parallel with the mounting bracket and secured for storage.

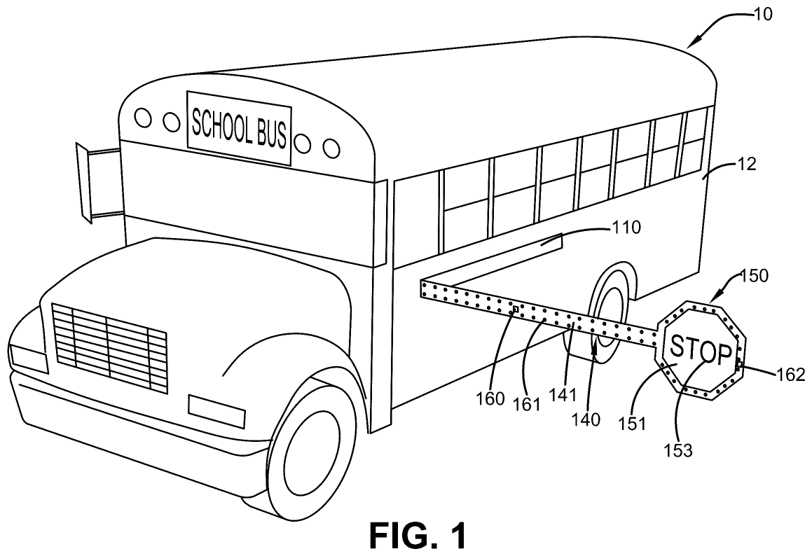

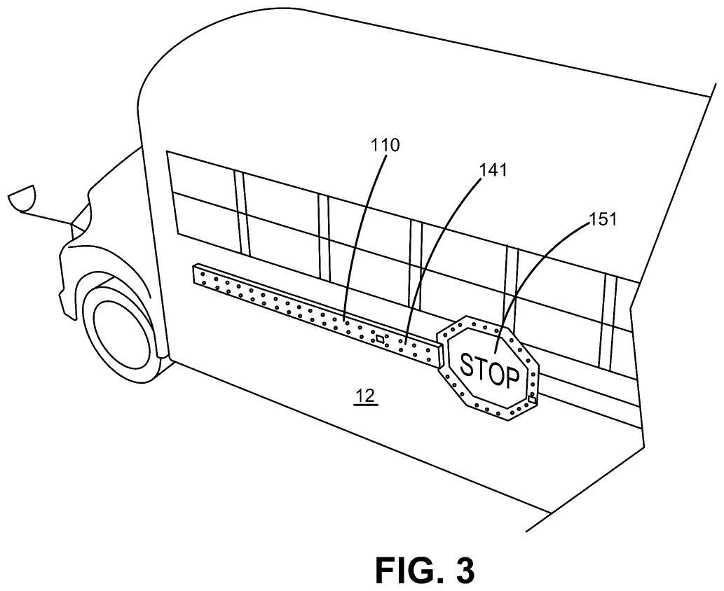

Referring initially to the drawings, FIGS. 1-3, illustrate a perspective view of one embodiment of the retractable safety sign device 100 of the present invention. In the present embodiment, the retractable safety sign device 100 is an improved safety sign device 100 that provides a user with enhanced safety when school children or pedestrians are crossing a roadway. Specifically, the retractable safety sign device 100 is comprised of a sign 150 and traffic-lane-blocking arm 140 that can be extended from the side surface 12 of a vehicle 10 such as but not limited to a school bus. As a result, the sign 150 warns drivers in a lane next to the vehicle 10 to stop, and the arm 140 prevents the drivers from driving past to vehicle 10. This ensures children crossing the roadway cannot be hit by drivers in other lanes.

Further, the device 100 is comprised of at least one mounting bracket 110. The bracket 110 may be any size, shape, and configuration. The bracket 110 can be attached to a side surface 12 of a vehicle 10 (such as but not limited to a school bus) via at least one fastener 112 such as but not limited to a screw, a bolt, etc. At least one arm 140 connects to the mounting bracket 110 via at least one hinge 130 of any type. Furthermore, at least one powered actuator arm 132 connects the arm 140 to the bracket 110. The actuator arm 132 may attach to the bracket 110 via at least one hinge 133 in one embodiment. The actuator arm 132 is preferably a hydraulic or electric powered arm. The actuator arm 132 enables the arm 140 to extend up to 90-degrees relative to the horizontal axis of the bracket 110. In this manner, the arm 140 can be positioned generally parallel with a side surface 12 of a vehicle 10 when stored and not in use. When deployed, the arm 140 extends from the bracket 110 to a perpendicular or orthogonal position (as noted above) in order to block a lane of traffic as well as position at least one sign 150 in the lane. In one embodiment, the arm 140 is comprised of at least one channel 143, wherein the actuator arm 132 can move laterally within the channel 143 when the arm 140 is extended or retracted.

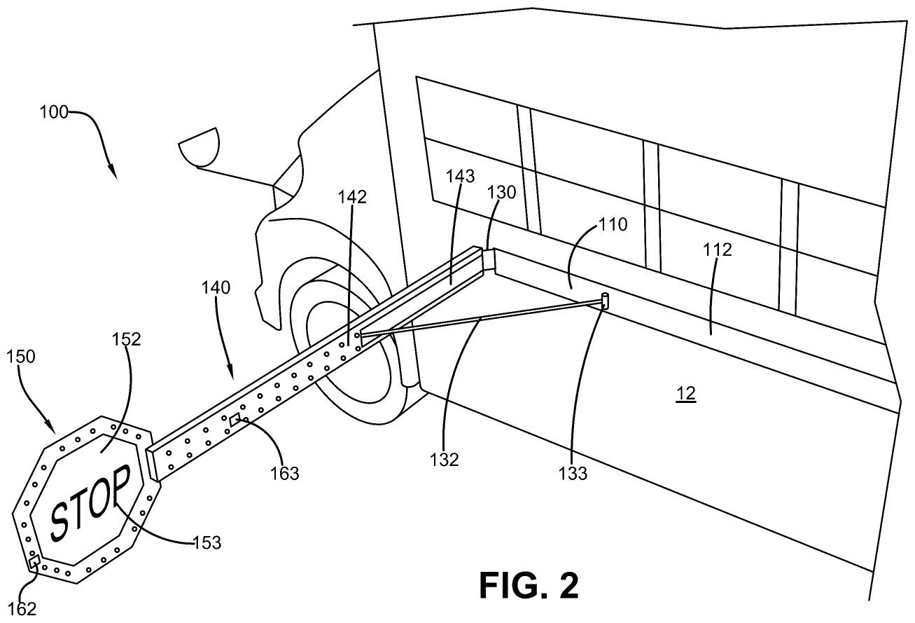

As shown in FIGS. 1-2, the device 100 is also comprised of at least one sign 150 attached to the arm 140. The sign 150 is preferably a red octagonal shape but may be any shape and any color. The front surface 151 and/or rear surface 152 of the sign 150 and the front surface 141 and/or rear surface 142 of the arm 140 may also be comprised of at least one indicia 153. The indicia 153 is preferably “stop” but may be any word, phrase, symbol etc. that may relate to stopping traffic and indicating occupants of the vehicle 10 are crossing a roadway. To further ensure the arm 140 and sign 150 are visible, the front surfaces 141, 151 and/or rear surface 142, 152 may be comprised of at least one reflective element 160 of any color and at least one light 161 of any color. The light 161 may also illuminate in any pattern such as but not limited to continuous illumination, flashing illumination, etc. Finally, the device 100 is also comprised of at least one camera 162 and at least one sound alert 163 component for enhanced safety to children or pedestrians

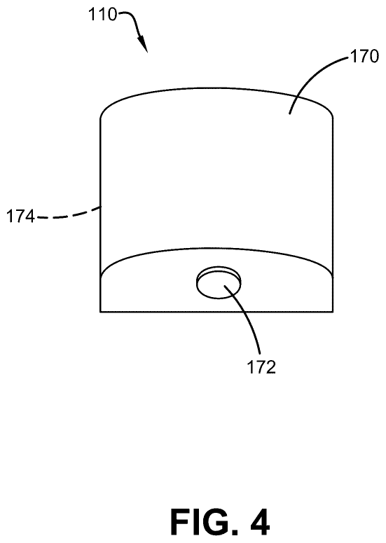

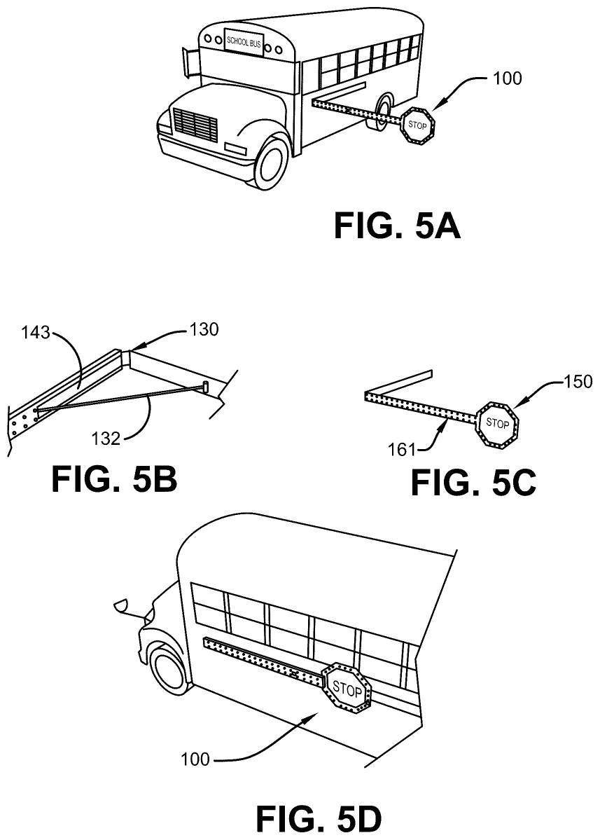

As shown in FIGS. 4, 5A, 5B, 5C, and 5D, the device 100 is comprised of an arm 140, preferably wired or wireless communication with at least one control 170. The control 170 may be positioned within the vehicle 10. When at least one button 172 of the control 170 is pressed, the actuator arm 132 extends or retracts the arm 140. When the actuator arm 132 is extended, the sign 150, indicia, light 161, reflective element 160, camera 162, and sound element 163 are engaged for optimal safety.

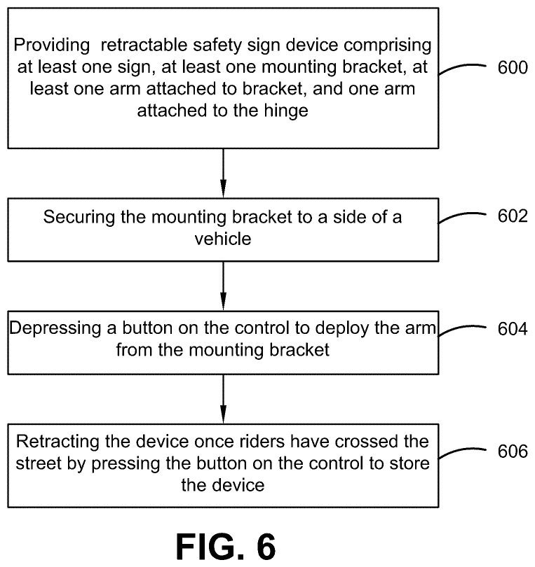

FIG. 6 illustrates a flowchart of the method of using the device 100. The present invention is also comprised of a method of using 600 the device 100. The method includes steps of at 600, providing a device 100 comprised of at least one sign 150, at least one control 170, at least one mounting bracket 110, and at least one arm 140 attached to the mounting bracket 110 via at least one hinge 130 and at least one arm 140. The method also comprises at 602 securing the mounting bracket 110 to a side surface 12 of a vehicle 10. Further, the method at 604 comprises depressing the button 172 of the control 170 to deploy the arm 140 from the bracket 110 such that the arm 140 is deployed generally 90-degrees (i.e., orthogonally) from the horizontal axis of the bracket 110 when the vehicle 10 stops and riders of the vehicle 10 may be crossing a roadway. Finally, the method comprises at 606 once the riders have crossed, depressing the button 172 to retract the arm 140 such that it is generally parallel with the mounting bracket 110 for storage.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “retractable safety sign device”, “safety sign device”, “sign device”, and “device” are interchangeable and refer to the retractable safety sign device 100 of the present invention.

Notwithstanding the forgoing, the retractable safety sign device 100 of the present invention can be of any suitable size and configuration as is known in the art without affecting the overall concept of the invention, provided that it accomplishes the above stated objectives. One of ordinary skill in the art will appreciate that the retractable safety sign device 100 as shown in FIGS. 1-6 is for illustrative purposes only, and that many other sizes and shapes of the retractable safety sign device 100 the retractable safety sign device are well within the scope of the present disclosure. Although the dimensions of the retractable safety sign device 100 are important design parameters for user convenience, the retractable safety sign device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A retractable vehicular safety sign device comprising;
a selectively retractable sign;
a blocking arm;
a mounting bracket;
a vehicle;
a first hinge; and
an actuator arm;
wherein said blocking arm is a traffic-lane-blocking arm extendable from a side surface of said vehicle;
wherein said mounting bracket attachable to said side surface of said vehicle;
wherein said traffic-lane-blocking arm selectively extendable orthogonally from said side surface of said vehicle;
wherein said traffic-lane-blocking arm connectable to said mounting bracket with said first hinge; and
further wherein said traffic-lane-blocking arm selectively retractable.

2. The retractable vehicular safety sign device of claim 1, wherein said vehicle is a school bus.

3. The retractable vehicular safety sign device of claim 1, wherein said first hinge connecting said traffic-lane-blocking arm and said mounting bracket.

4. The retractable vehicular safety sign device of claim 1, wherein said actuator arm is a powered actuator arm for actuating said traffic-lane-blocking arm from a retracted position to an extended position.

5. The retractable vehicular safety sign device of claim 4 further comprising a second hinge, wherein said second hinge connecting said powered actuator arm and said mounting bracket.

6. The retractable vehicular safety sign device of claim 5, wherein said powered actuator arm is a hydraulic powered actuator arm.

7. The retractable vehicular safety sign device of claim 5, wherein said powered actuator arm is an electric powered actuator arm.

8. The retractable vehicular safety sign device of claim 5, wherein said powered actuator arm fixing said traffic-lane-blocking arm orthogonally to said side surface of said vehicle.

9. The retractable vehicular safety sign device of claim 8, wherein said first hinge and said second hinge simultaneously pivotable for actuating said traffic-lane-blocking arm from the retracted position to the extended position.

10. The retractable vehicular safety sign device of claim 9, wherein said traffic-lane-blocking arm aligned along said mounting bracket when in the retracted position.

11. The retractable vehicular safety sign device of claim 10, wherein said traffic-lane-blocking arm having a stop sign at a terminal end.

12. The retractable vehicular safety sign device of claim 11, wherein said traffic-lane-blocking arm having a channel for movement of said powered actuator arm therein.

13. The retractable vehicular safety sign device of claim 12, wherein said stop sign having a first reflective element on a first side of said stop sign and a second reflective element on a second opposing side of said stop sign.

14. The retractable vehicular safety sign device of claim 13, wherein said first reflective element and said second reflective element having continuous illumination.

15. The retractable vehicular safety sign device of claim 14, wherein said first reflective element and said second reflective element having flashing illumination.

16. A retractable vehicular safety sign device comprising;
a selectively retractable sign;
a blocking arm;
a mounting bracket;
a vehicle;
a first hinge; and
an actuator arm;
wherein said blocking arm is a traffic-lane-blocking arm extendable from a side surface of said vehicle;
wherein said mounting bracket attachable to said side surface of said vehicle;
wherein said traffic-lane-blocking arm selectively extendable orthogonally from said side surface of said vehicle;
wherein said traffic-lane-blocking arm connectable to said mounting bracket with said first hinge;
wherein said traffic-lane-blocking arm selectively retractable;
wherein said stop sign having a first reflective element on a first side of said stop sign and a second reflective element on a second opposing side of said stop sign;
wherein said stop sign having a camera;
wherein said stop sign having a sound alert; and
further wherein said actuator arm is a powered actuator arm for actuating said traffic-lane-blocking arm from a retracted position to an extended position.

17. A method of actuating a retractable vehicular safety sign device, the method comprising the steps of:
providing a selectively retractable sign, a blocking arm, a mounting bracket, a vehicle, a first hinge, and an actuator arm, wherein said blocking arm is a traffic-lane-blocking arm extendable from a side surface of said vehicle;
attaching said mounting bracket to said side surface of said vehicle;
connecting said traffic-lane-blocking arm to said mounting bracket with said first hinge; and
selectively actuating said traffic-lane-blocking arm from a retracted position aligned with said mounting bracket to an extended position orthogonal to said vehicle, wherein said actuator arm is a powered actuator arm for actuating said traffic-lane-blocking arm from the retracted position to the extended position.

18. The method of actuating a retractable vehicular safety sign device of claim 17, wherein said traffic-lane-blocking arm having a stop sign at a terminal end.

19. The method of actuating a retractable vehicular safety sign device of claim 18 further comprising the steps of actuating a first reflective element on a first side of said stop sign and actuating a second reflective element on a second opposing side of said stop sign.

20. The method of actuating a retractable vehicular safety sign device of claim 19 further comprising the step of actuating a camera and a sound alert on said stop sign.
